(19) United States
(12) Patent Application Publication
(10) Pub. No.: US 2026/0102775 A1
(43) Pub. Date: Apr. 16, 2026

(54) Transparent Gold Pan and Recovery Wheel Device

(71) Applicant: Charles Matkin, IV, Chino, CA (US)

(72) Inventor: Charles Matkin, IV, Chino, CA (US)

(21) Appl. No.: 19/351,368

(22) Filed: Oct. 7, 2025

Related U.S. Application Data
(60) Provisional application No. 63/707,998, filed on Oct. 16, 2024.

(51) Int. Cl. B03B 5/02; B03B 5/74

(52) U.S. Cl. CPC B03B 5/02; B03B 5/74

(57) ABSTRACT

A transparent gold pan and recovery wheel device is provided. The device is comprised of a pan body configured for visual inspection and mechanical separation of gold and dense particulate matter from soil. The pan body is transparent or translucent with a sloped inner surface that channels material toward a central basin during agitation. Integrated spiral or alternative guiding structures aid stratification. A silicone protector attaches to the body and houses white and ultraviolet LED lights for enhanced visibility. An adjustable magnifying glass mounts above the body for focused observation. Insert discs may further enhance material contrast. The pan mounts on a motorized platform comprising a rotating and vibrating angled recovery wheel. A spray nozzle assembly directs pressurized water to displace lighter debris while retaining heavier material. The transparent body enables multi-angle viewing, including from beneath, allowing continuous visual feedback during manual and mechanical separation phases.

### CROSS-REFERENCE TO RELATED APPLICATION

The present application claims priority to, and the benefit of, U.S. Provisional Application No. 63/707,998, which was filed on Oct. 16, 2024, and is incorporated herein by reference in its entirety.

### FIELD OF THE INVENTION

The present invention relates generally to the field of gold mining. More specifically, the present invention relates to a transparent sloped pan with integrated guiding structures, illumination, magnification, and contrast-enhancing inserts. The pan attaches to a motorized, vibrating, and angled platform with a spray nozzle assembly that directs pressurized water to displace lighter material while concentrating heavier particles for efficient recovery and continuous visual feedback. Accordingly, the present disclosure makes specific reference thereto. Nonetheless, it is to be appreciated that aspects of the present invention are also equally applicable to other like applications, devices, and methods of manufacture.

### BACKGROUND

Traditional gold panning methods rely heavily on manual labor and visual approximation to identify and separate dense particles such as gold from lighter sediment. Typically, a pan with ridges is used to retain gold while water and lighter materials are washed away during agitation. However, this method is both time-consuming and inconsistent, especially when working with fine particulate gold or in suboptimal lighting conditions. Prospectors often encounter difficulty in visually confirming the presence of gold due to obstructed views, particularly when using opaque pans or when dealing with dark sediment such as black sand. The inability to clearly observe the stratification process results in prolonged effort and potentially missed gold recovery. Additionally, traditional systems separate the panning function from more advanced mechanical recovery tools, requiring multiple devices and manual transfers of material. This separation increases both time and risk of loss during transitions. The lack of visual transparency and the need for multiple devices present a substantial obstacle to efficiency and success in gold recovery.

Therefore, there exists a long-felt need in the art for a transparent gold pan and recovery wheel device that allows users to observe material movement and stratification directly through the pan during use. There also exists a long-felt need in the art for a transparent gold pan and recovery wheel device that integrates both manual panning and mechanized recovery functionality within a single platform. Moreover, there exists a long-felt need in the art for a transparent gold pan and recovery wheel device that facilitates accurate, real-time visual inspection of particulate material through transparent components and magnification.

The subject matter disclosed and claimed herein, in one embodiment thereof, comprises a transparent gold pan and recovery wheel device. The device is comprised of a device configured to optimize the visual inspection and mechanical separation of gold and dense particulate matter from soil and sediment. The invention comprises a transparent or translucent pan body with a sloped inner surface that guides dense materials toward a central basin during agitation. The body may be comprised of integrated spiral or alternative guiding structures molded into the inner surface to aid stratification during shaking or swirling. A universal silicone protector may attach to the pan body and houses illumination components comprising white and ultraviolet LED lights, enhancing material visibility during inspection. A magnifying glass with adjustable focal length is also mountable above the body to provide focused observation of fine particles. Insert discs of varying color and texture are positionable within or beneath the pan to increase contrast with the material being processed. The pan is operatively mounted to a motorized platform comprising a rotating and vibrating angled recovery wheel surface that holds the pan securely. The platform includes a spray nozzle assembly that directs pressurized water onto the pan to assist in material separation by displacing lighter debris while retaining heavier elements in the pan's basin or ridges. The transparency of the pan body allows users to view the separation process from multiple angles, including from beneath the pan during active operation, providing continuous visual feedback throughout both manual and mechanical recovery phases.

In this manner, the transparent gold pan and recovery wheel device of the present invention accomplishes all the foregoing objectives and provides a device that enables real-time, multi-angle visual inspection of stratification through the use of optically transparent materials and integrated magnification and lighting components. More specifically, the clear body of the pan permits direct viewing of gold particles from above and below, enhancing accuracy and reducing reliance on guesswork. By combining a traditional gold panning basin with a motorized recovery wheel platform, the invention consolidates manual and mechanical gold recovery operations into a single, cohesive system. The inclusion of spiral guiding structures, insert discs, and a spray nozzle assembly further ensures effective separation of materials during both manual and automated processes. This integrated configuration significantly reduces processing time, increases recovery rates of fine particulate gold, and eliminates the inefficiencies associated with using multiple disjointed tools.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a transparent gold pan and recovery wheel device. The device is designed for efficient separation and identification of gold and other dense materials from soil, sand, and sediment during prospecting activities. More specifically, the device enhances visual clarity, reduces manual panning time, and increases recovery rates of fine gold by promoting stratification and targeted inspection of heavy particles.

The device is comprised of a generally circular pan body having a shallow conical profile that enables gravitational settling of dense materials toward a central basin during agitation. The inner surface slopes gradually from a wide top rim to a narrow central basin, concentrating material and improving visibility. The conical slope may vary in steepness to control material centralization and inspection time.

The body is comprised of a clear or translucent material such that the body allows observation of material from below, improving accuracy and reducing the volume of sediment processed. Alternate embodiments may include opaque or multi-colored bodies to provide background contrast.

The inner surface is further comprised of a plurality of guiding structures, such as spiral ridges extending from the central basin toward the top rim, configured to guide dense particles during manipulation. To further support visual inspection, the device may be comprised of a universal protector made from a transparent material such as silicone. The protector may attach to the bottom or top rim of the body, depending on body transparency. The protector may include a series of illumination elements such as white and ultraviolet LED lights to enhance visibility and aid in material identification. The device may be comprised of at least one magnifying glass attached via a fastener to any area of the body. The magnifying glass may be fixed or adjustable and may be positioned centrally above the body to allow focused inspection of particulate matter.

The device may also be comprised of removable color insert discs placed between the body and protector or within the body or to the bottom of the body. The discs may be comprised of materials such as laminated paper, polymer films, or silicone and may be selected in various colors and textures to enhance contrast and visibility of specific materials.

The device may further be comprised of a motorized platform with a base structure supporting a rotating platform. The rotating platform includes a receiving area configured to retain the body. The receiving area may be positioned on an angled top surface forming an angle between 1 and 89 degrees relative to the vertical axis. The rotating platform is driven by at least one or more motors configured for bidirectional rotation and vibration that enhances the separation and suspension of ultrafine particles within the body.

The platform may also be comprised of a spray nozzle assembly mounted to the top surface using at least one mounting arm. The assembly includes repositionable nozzles that direct pressurized water from an external source into the body during operation. During use, as the body is rotated and vibrated at an angle, water emitted from the spray nozzles facilitates the stratification of heavy materials into the guiding structures and central basin, while lighter materials are washed over the edge into a collection or discard area below.

Accordingly, the transparent gold pan and recovery wheel device of the present invention is particularly advantageous as it provides a device that enables real-time, multi-angle visual inspection of stratification through the use of optically transparent materials and integrated magnification and lighting components. More specifically, the clear body of the pan permits direct viewing of gold particles from above and below, enhancing accuracy and reducing reliance on guesswork. By combining a traditional gold panning basin with a motorized recovery wheel platform, the invention consolidates manual and mechanical gold recovery operations into a single, cohesive system. The inclusion of spiral guiding structures, insert discs, and a spray nozzle assembly further ensures effective separation of materials during both manual and automated processes. This integrated configuration significantly reduces processing time, increases recovery rates of fine particulate gold, and eliminates and overcomes the inefficiencies associated with using multiple disjointed tools.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a pan of one potential embodiment of a transparent gold pan and recovery wheel device of the present invention in accordance with the disclosed architecture;

FIG. 2 illustrates a perspective side view of a pan of one potential embodiment of a transparent gold pan and recovery wheel device of the present invention in accordance with the disclosed architecture;

FIG. 3 illustrates a side view of one potential embodiment of a transparent gold pan and recovery wheel device of the present invention wherein the pan is attached to the motorized platform in accordance with the disclosed architecture; and

FIG. 4 illustrates a flowchart of a method of using one potential embodiment of a transparent gold pan and recovery wheel device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a transparent gold pan and recovery wheel device that allows users to observe material movement and stratification directly through the pan during use. There also exists a long-felt need in the art for a transparent gold pan and recovery wheel device that integrates both manual panning and mechanized recovery functionality within a single platform. Moreover, there exists a long-felt need in the art for a transparent gold pan and recovery wheel device that facilitates accurate, real-time visual inspection of particulate material through transparent components and magnification.

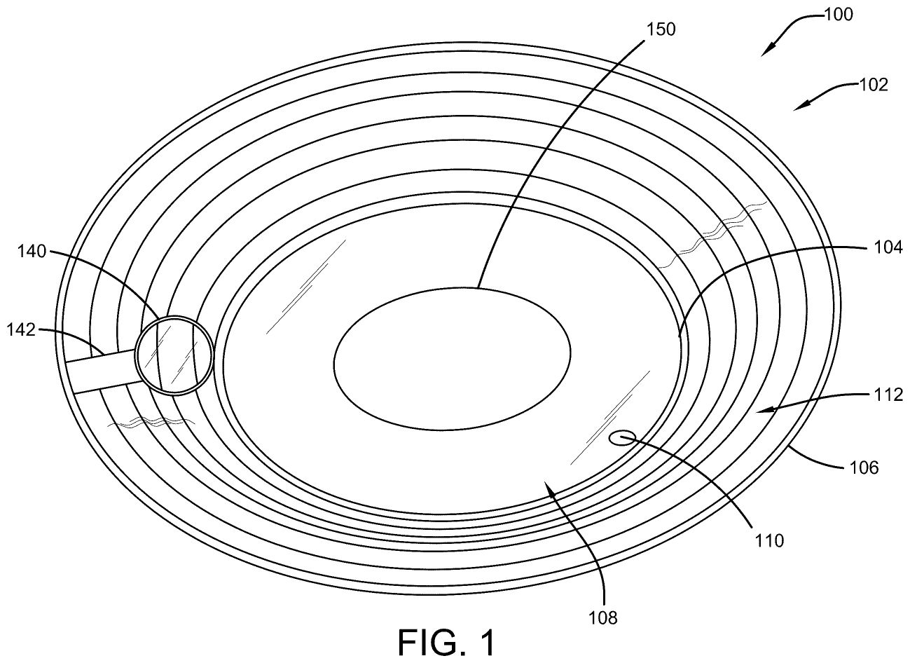

Referring initially to the drawings, FIG. 1 illustrates a perspective view of a pan 102 of one potential embodiment of a transparent gold pan and recovery wheel device 100 of the present invention in accordance with the disclosed architecture. The device 100 is designed for the efficient separation and identification of gold and other materials from soil, sand, and sediment during prospecting activities. More specifically, the device 100 improves visual clarity, reducing the time traditionally required for manual panning, and increases the recovery rate of fine gold and other material by facilitating stratification and targeted inspection of heavy particles.

The device 100 may be comprised of a pan body 102 that may be generally circular in shape, with a shallow conical profile that facilitates the gravitational settling of dense materials toward the center of the body 102 during agitation. The inner surface 104 of the body 102 may slope gradually from a wide, open top rim 106 to a narrower central basin area 108, as seen in FIG. 1. The sloped configuration concentrates material within the central basin area 108 during shaking or swirling of the body 102, improving visibility and simplifying the separation of heavy particles. The degree of conicity of the body 102 may vary, with some embodiments incorporating a steeper slope to accelerate centralization of materials, while other configurations may include a more gradual taper to prolong stratification and inspection time. In alternate embodiments, the body 102 may be any shape such as but not limited to polygonal, elliptical, oblong, or irregular geometries.

The body 102 may be made from clear or translucent material such as but not limited to any combination of polycarbonate, acrylic, or other scratch-resistant plastics that exhibit high optical clarity and durability. The material may be selected to offer varying levels of light transmission. In certain embodiments, a coating 110 such as but not limited to anti-fog or anti-reflective coatings may be applied to one or more surfaces of the body 102 to further enhance usability under variable environmental conditions. The clear composition of the body 102 enables the user to observe material, such as but not limited to gold, through the underside of the body 102, allowing for inspection of panned material after minimal shaking or agitation. This transparency may eliminate the need for prolonged manual separation, reducing the amount of earth or sediment that must be processed while increasing the speed and accuracy of gold or other dense particulate detection. In one embodiment, the body 102 is not transparent and may instead be comprised of solid-colored or opaque materials to provide background contrast rather than underside visibility. In one embodiment, the body 102 may be multiple colors to various contrast levels or types.

The inner surface 104 of the body 102 may further be comprised of a plurality of guiding structures 112, as seen in FIG. 1. The structures 112 may be, but are not limited to, spiral ridges that extend from the central basin area 108 of the body toward the outer top rim 106. Said spiral ridges may be configured to guide dense particles upward as the body is manipulated, assisting in the stratification of material. The spiral pattern further enhances the separation process by creating multiple directional flow paths for heavy particulates such as gold, black sand, and gemstones. In other embodiments, the structures 112 may include but are not limited to concentric ridges, irregular bumps, cross-hatched grooves, waveforms, or multi-angled facets. In any embodiment, the structures 112 may vary in height, pitch, and spacing to influence material flow dynamics. In spiral embodiments, the spirals may be in any arrangement, orientation, or directional sequence such as but not limited to any combination of clockwise, counterclockwise, overlapping, asymmetrical, or interwoven patterns. The guiding structures 112 may be integrally molded with the body 102.

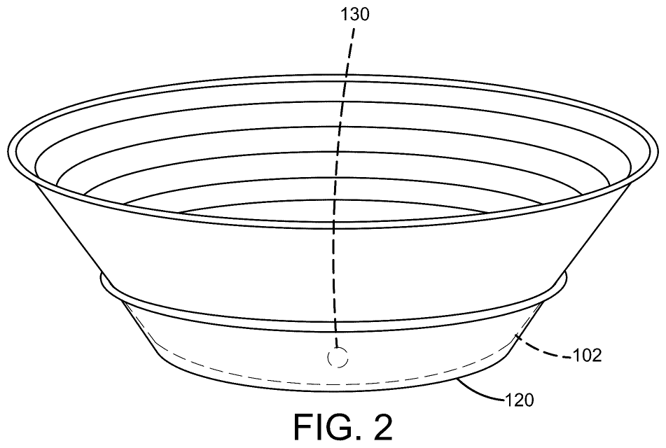

To accommodate varying lighting conditions and enhance visual inspection, the device 100 may further be comprised of a universal protector 120, as seen in FIG. 2. The protector 120 is preferably transparent and may be of a material such as but not limited to a silicone. The protector 120 may be configured to attach to and/or around a bottom area 103 of the body 102 in embodiments wherein the body 102 is transparent via snap fit or other means. In embodiments where the body 102 is colored, the protector 120 may be secured to the top rim 106 to create a sealed or enclosed upper boundary for controlled inspection from above. The protector 120 may be comprised of a series of illumination elements 130 such as but not limited to six white LED lights and six ultraviolet (UV) LED lights that may improve visibility and aid in identifying materials within the body 102 that fluoresce or reflect differently under various wavelengths of light. However, the elements 130 may be any type or color and may be arranged in any position such as evenly spaced, clustered, or selectively grouped around the protector 120.

In one embodiment, the device 100 is also comprised of at least one magnifying glass 140 that may attach to any area of the body 102 via at least one fastener 142 such as but not limited to a clip, a clamp, etc. The glass 140 may be positioned centrally above the body 102 in one embodiment, enabling focused inspection of fine particulate matter within the body 102. The magnifying lens 140 may be fixed or adjustable in focal length in one embodiment to allow for different observation preferences.

The device 100 may also be used in combination with removable color insert discs 150 that may be placed between the body 102 and the protector 120 and/or within the body 102, as seen in FIG. 1. The insert discs 150 may be a range of colors, textures, and materials to provide visual contrast for specific materials. For example, certain hues such as blue, orange, or black may be selected to enhance the visibility of fine gold, precious metals, or gemstones during the panning process. The insert discs 150 may be comprised of materials such as but not limited to any combination of laminated paper, colored polymer films, or dyed silicone layers.

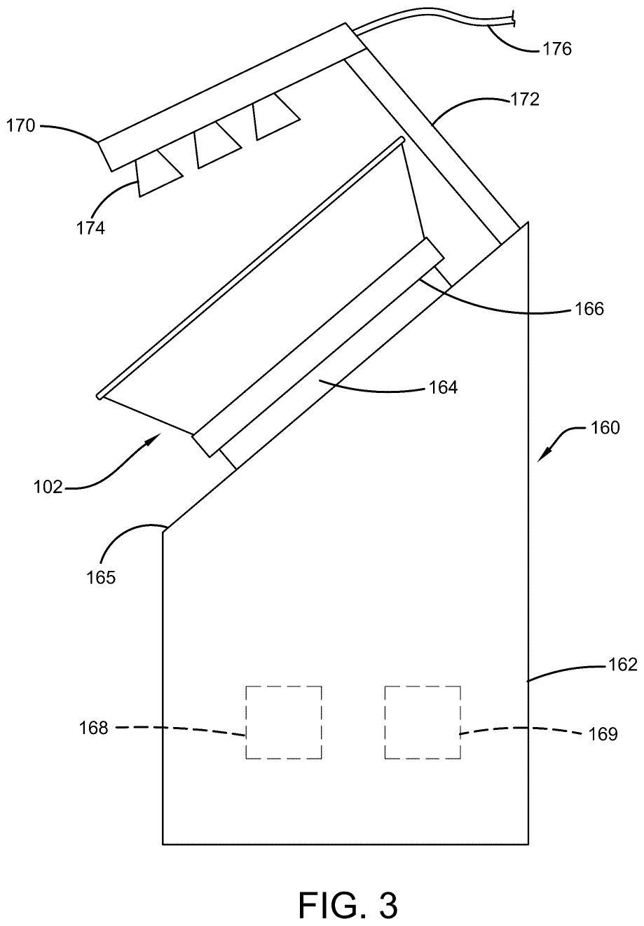

The device 100 may further be comprised of a motorized platform 160, as seen in FIG. 3. The motorized platform 160 may be comprised of a base structure 162 supporting a rotating platform 164. The rotating platform 164 may include at least one receiving area 166 configured to receive and retain the body 102 during operation. The receiving area 166 may be configured as but not limited to an indented surface, a recessed seating profile, a friction-fit socket, or at least one mechanical fastener such as a clip, clamp, or adjustable band to securely hold the body 102 in place.

The receiving area 166 may be positioned on an angled top surface 165 of the rotating platform 164, the surface 165 forming an angle between 1 and 89 degrees relative to the vertical axis of the platform 160. In one embodiment, the angle may be adjustable to accommodate different stratification profiles or particulate behaviors.

The rotating platform 164 may be driven by at least one motor 168. The motor 168 may be configured to rotate the platform in one or more directions and may further be configured to generate vibrational motion. The motor 168 may be powered by at least one power source 169 such as but not limited to a removable battery pack, a solar panel, DC power, a rechargeable battery, or a wired power supply. The vibrational and rotational movement induced by the motor 168 may enhance the separation and suspension of ultrafine particles such as 300-plus mesh gold dust within the body 102.

The platform 169 may further be comprised of a spray nozzle assembly 170 mounted to the top surface 165 via at least one mounting arm 172, as seen in FIG. 3. The spray nozzle assembly 170 may be comprised of a plurality of nozzles 174 configured to receive pressurized water through at least one hose 176 connected to an external water source. The nozzles 174 may be repositionable and directed toward the body 102 when the body 102 is secured in the receiving area 166.

During operation, as the body 102 is rotated and vibrated at an angle while attached to the platform 160, the spray nozzle assembly 170 may emit water directed onto the inner surface 104 of the body 102. This combined application of rotation, vibration, and directed water flow may facilitate the stratification of heavy materials such as gold into the guiding structures 112 and/or the central basin area 108 of the body 102, while less dense materials are washed over the edge of the body 102 into a collection or discard area positioned below the body 102.

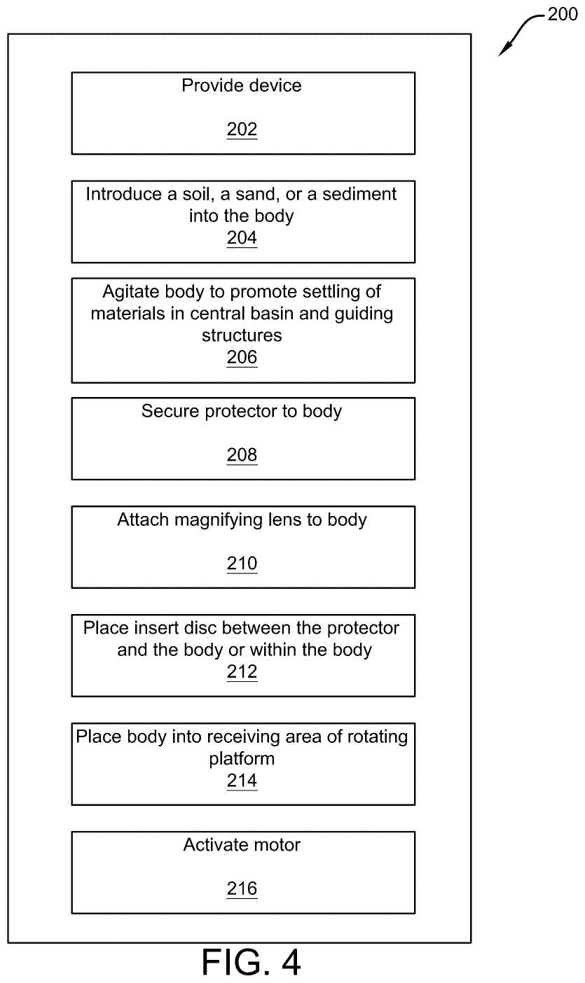

The present invention is also comprised of a method of using the device, as seen in FIG. 4. First, a device 100 is provided comprised of a body 102 having an inner surface 104 with a plurality of guiding structures 112, and optionally further comprising a protector 120, at least one magnifying glass lens 140, at least one insert disc 150, and a motorized platform 160 with an angled rotating platform 164 and spray nozzle assembly 170 [Step 202]. Then, a quantity of soil, sand, or sediment may be introduced into the body 102 such that the material settles toward the central basin area 108 of the body 102 [Step 204]. Next, the user may manually agitate the body 102 by shaking or swirling to promote gravitational settling of heavy materials into the central basin 108 and along the guiding structures 112 [Step 206]. The protector 120 could then be secured to the body 102 depending on the transparency of the body 102, thereby enhancing visual clarity and inspection control [Step 208]. The magnifying glass lens 140 may be attached to a desired position on or above the body 102 for focused observation of particulate matter within the body 102 during or after agitation [Step 210]. The user may optionally place an insert disc 150 between the protector 120 and body 102 to introduce color contrast that highlights specific material properties such as reflectivity or fluorescence [Step 212]. The body 102 may then be placed into the receiving area 166 of the rotating platform 164 of the motorized platform 160, which may be angled between 1 and 89 degrees relative to vertical, and secured via a seating profile or mechanical fastener [Step 214]. The user may activate the motor 168 to initiate rotation and/or vibration of the platform 164, causing additional stratification and movement of ultrafine particles within the body 102 [Step 216]. Concurrently, the spray nozzle assembly 170 may be activated to direct water flow into the interior of the body 102, assisting in the suspension of lighter materials and concentrating denser particles within the guiding structures 112 or central basin area 108.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “transparent gold pan and recovery wheel device” and “device” are interchangeable and refer to the transparent gold pan and recovery wheel device 100 of the present invention.

Notwithstanding the foregoing, the transparent gold pan and recovery wheel device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the transparent gold pan and recovery wheel device 100 as shown in the FIGS. are for illustrative purposes only, and that many other sizes and shapes of the transparent gold pan and recovery wheel device 100 are well within the scope of the present disclosure. Although the dimensions of the transparent gold pan and recovery wheel device 100 are important design parameters for user convenience, the transparent gold pan and recovery wheel device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A gold pan device comprising:
a pan body having an inner surface with a sloped configuration extending from a top rim to a central basin area, wherein the inner surface is comprised of a plurality of guiding structures configured to facilitate stratification.

2. The gold pan device of claim 1 further comprised of a protector that attaches to the pan body.

3. The gold pan device of claim 2, wherein the protector is comprised of an illumination element.

4. The gold pan device of claim 1 further comprised of a magnifying lens.

5. The gold pan device of claim 4, wherein the magnifying lens attaches to the transparent pan body.

6. The gold pan device of claim 1 further comprised of a removable insert disc comprised of a color.

7. The gold pan device of claim 6, wherein the removable insert disc is positioned within the transparent body.

8. The gold pan device of claim 1, wherein the plurality of guiding structures are comprised of a plurality of spiral ridges.

9. The gold pan device of claim 1, wherein the pan body is transparent.

10. The transparent gold pan and recovery wheel device of claim 1, wherein the pan body is opaque.

11. A transparent gold pan and recovery wheel device comprising:
a transparent pan body having an inner surface with a sloped configuration extending from a top rim to a central basin area, wherein the inner surface is comprised of a plurality of guiding structures configured to facilitate stratification; and
a motorized platform comprising a rotating platform having a receiving area configured to retain the transparent pan body, a motor, and a spray nozzle assembly.

12. The transparent gold pan and recovery wheel device of claim 11 further comprised of a hose.

13. The transparent gold pan and recovery wheel device of claim 11 further comprised of a battery, a solar panel, or a DC power.

14. The transparent gold pan and recovery wheel device of claim 11, wherein the spray nozzle assembly is comprised of a nozzle.

15. The transparent gold pan and recovery wheel device of claim 11, wherein the pan body is transparent.

16. The transparent gold pan and recovery wheel device of claim 11, wherein the pan body is opaque.

17. The transparent gold pan and recovery wheel device of claim 11, wherein the motor generates a vibrational motion.

18. The transparent gold pan and recovery wheel device of claim 11, wherein the motor rotates the rotational platform.

19. The transparent gold pan and recovery wheel device of claim 11, wherein the motorized platform is comprised of a battery.

20. A method of using a transparent gold pan and recovery wheel device, the method comprising the following steps:
providing a transparent gold pan and recovery wheel device comprised of a pan body with an inner surface having a plurality of guiding structures, a protector that attaches to the pan body, a magnifying glass lens that attaches to the pan body or the protector, an insert disc positionable within the pan body, and a motorized platform comprised of a rotating platform and a spray nozzle assembly;
introducing a soil, a sand, or a sediment into the pan body;
agitating the pan body to promote a gravitational settling of a heavy material in the soil, the sand, or the sediment toward a central basin area of the pan body and along the plurality of guiding structures;
securing the pan body to the rotating platform of the motorized platform;
activating a motor of the motorized platform to induce a rotation and a vibration of the rotating platform; and
activating the spray nozzle assembly to direct a water flow into the pan body.
